(19) United States
(12) Patent Application Publication
(10) Pub. No.: US 2005/0237549 A1
(43) Pub. Date: Oct. 27, 2005

(54) Method and apparatus for producing new color chart

(75) Inventors: Hyun-soo Oh, Suwon-si (KR); Kyeong-man Kim, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/110,889

(22) Filed: Apr. 21, 2005

(30) Foreign Application Priority Data
Apr. 22, 2004 (KR) 10-2004-0027770

(51) Int. Cl. H04N 1/60

(52) U.S. Cl. 358/1.9; 358/504; 358/518

(57) ABSTRACT

A method and apparatus for producing a new color chart is provided. In this method, first, a standard color chart is output using an image output unit. Then, a colorimetric value of the standard color chart output by the image output unit is detected. Then, a new color chart is produced by reconstructing the standard color chart using the colorimetric value. Accordingly, the new color chart enables a device-independent color space to have a uniform color distribution. Thus, an interpolation weight obtained from the device-independent color space is stable, and an error in a color image output by a printer or the like is minimized.

### CROSS-REFERENCE TO RELATED APPLICATION

This application claims the benefit of Korean Patent Application No. 10-2004-0027770, filed on Apr. 22, 2004, in the Korean Intellectual Property Office, the disclosure of which is incorporated herein in its entirety by reference.

### BACKGROUND OF THE INVENTION

1. Field of the Invention

The present invention relates to a color chart used to produce a color profile, and more particularly, to a method and apparatus for producing a color chart having a uniform color distribution in a device-independent color space to minimize an error generated upon color transformation.

2. Description of the Related Art

A method of producing a color profile includes operations of: outputting a standard color chart through an image outputting device for displaying, printing, or the like; measuring the output standard color chart using a colorimetric value detection device, such as, a spectrophotometer, a colorimeter, or a densitometer; and producing a color profile obtained by creating a table of the detected colorimetric values and the standard color chart. FIGS. 1A through 1C illustrate examples of a conventional standard color chart.

However, in the conventional standard color chart, colorimetric values may be concentrated in a specific area because of a mechanical property of an image output device.

FIGS. 2A and 2B illustrate three-dimensional color spaces in which a colorimeter values for a conventional standard color chart are represented by a gamut diagram. As illustrated in FIGS. 2A and 2B, colorimetric values of the gamut are concentrated in a specific area of a three-dimensional color space, and color samples are widely distributed in a peripheral area of the three-dimensional color space as indicated by an arrow. As a distance between color samples increases, that is, as the color samples are widely distributed, the color representation is accompanied with an error.

### SUMMARY OF THE INVENTION

Additional aspects and/or advantages of the invention will be set forth in part in the description which follows and, in part, will be obvious from the description, or may be learned by practice of the invention.

The present invention provides a method of producing a color chart having a uniform color distribution in a device-independent color space.

The present invention also provides an apparatus for producing a color chart having a uniform color distribution in a device-independent color space.

According to an aspect of the present invention, there is provided a method of producing a new color chart, including outputting a standard color chart using an image output unit, detecting a colorimetric value of the standard color chart output by the image output unit, and producing a new color chart by reconstructing the standard color chart using the colorimetric value.

According to another aspect of the present invention, there is provided an apparatus for producing a new color chart, including an image output unit outputting a standard color chart, a colorimetric value detection unit detecting a colorimetric value of the standard color chart output by the image output unit, and a color chart production unit producing a new color chart by reconstructing the standard color chart using the colorimetric value.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A through 1C illustrate examples of a conventional standard color chart;

FIGS. 2A and 2B illustrate three-dimensional color spaces in which a colorimeter value for a conventional standard color chart is represented;

FIG. 3 is a flowchart illustrating a method of producing a new color chart, according to an embodiment of the present invention;

FIG. 4 is a flowchart illustrating operation 14 of FIG. 3 in greater detail;

FIG. 5 illustrates a predetermined angle to represent that a color sample can be detected from a three-dimensional color space of a detected colorimetric value according to angle;

FIG. 6 illustrates a boundary area of a two-dimensional color sample for an angle detected from the three-dimensional color space of the detected colorimetric value;

FIG. 7 illustrates an example of a virtual coordinate table;

FIG. 8 illustrates points of contact detected by matching the two-dimensional sample with the virtual coordinate table;

FIGS. 9A and 9B are three-dimensional and two-dimensional color spaces, respectively, of a colorimetric value of a new color chart;

FIG. 10 is a block diagram of an apparatus for producing a new color chart, according to an embodiment of the present invention; and

FIG. 11 is a block diagram of a color chart production unit of FIG. 10.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

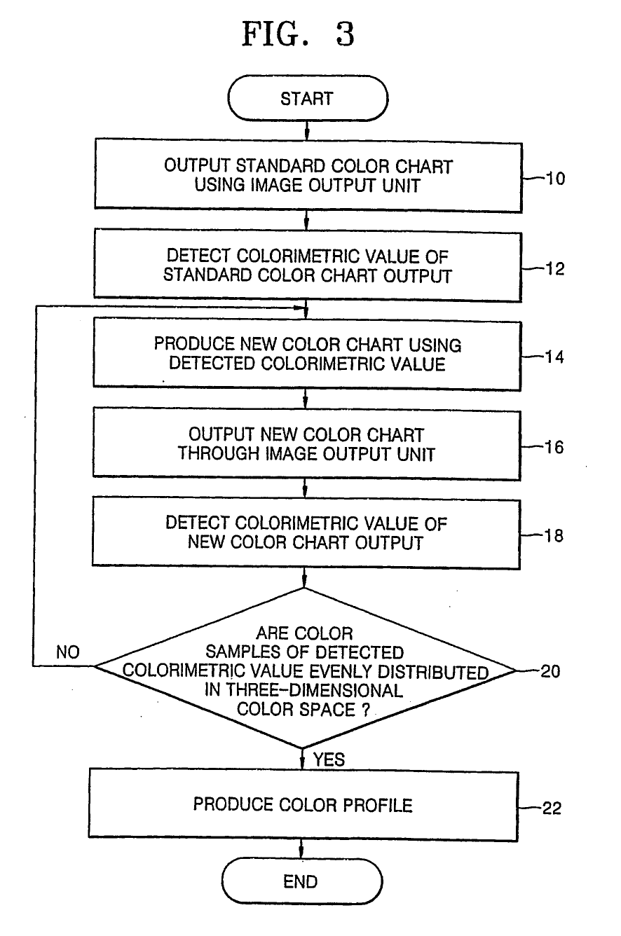

FIG. 3 is a flowchart illustrating a method of producing a new color chart, according to an embodiment of the present invention. The method includes operations 10 through 22 of producing a new color chart and checking a distribution of color samples for the new color chart to produce a color profile.

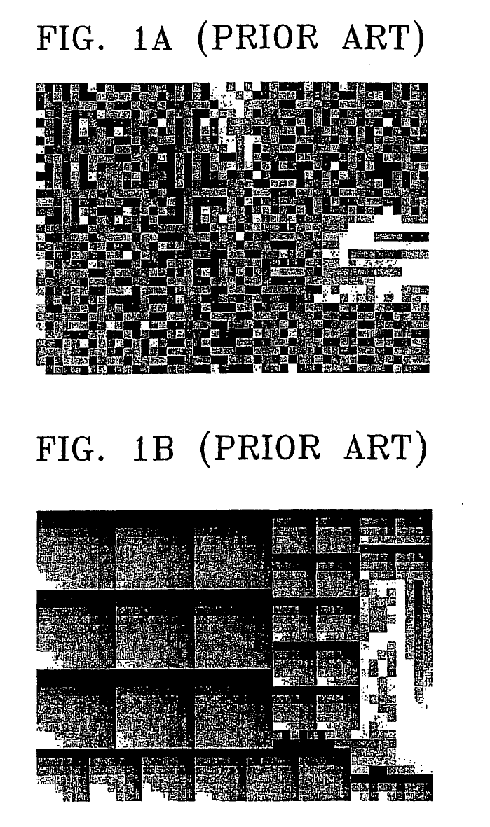

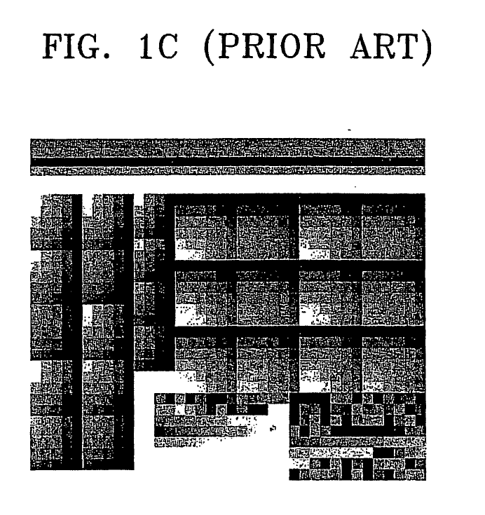

First, in operation 10, a standard color chart is output using an image output unit. For example, a standard color chart illustrated in FIG. 1A, 1B, or 1C is output. Examples of the image output unit include a printer for printing an image, a computer monitor for displaying an image on a screen, and the like.

Thereafter, in operation 12, a colorimetric value of the standard color chart output is detected using a colorimetric value detection device, such as a spectrometer, a colorimeter, a densitometer, or the like.

Next, in operation 14, a new color chart is produced by reconstructing the standard color chart using the detected colorimetric value.

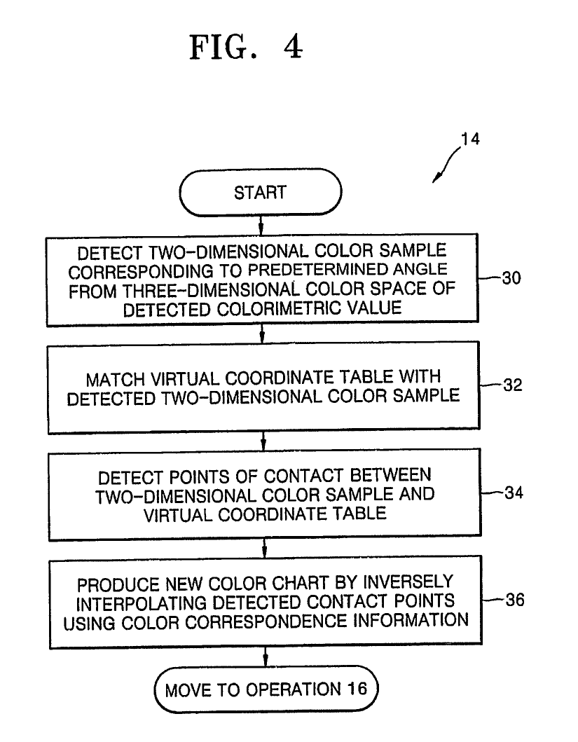

FIG. 4 is a flowchart illustrating operation 14 in greater detail. Operation 14 includes sub-operations 30 through 36 of inversely interpolating points of contact between a virtual coordinate table and a two-dimensional color sample and producing a new color chart.

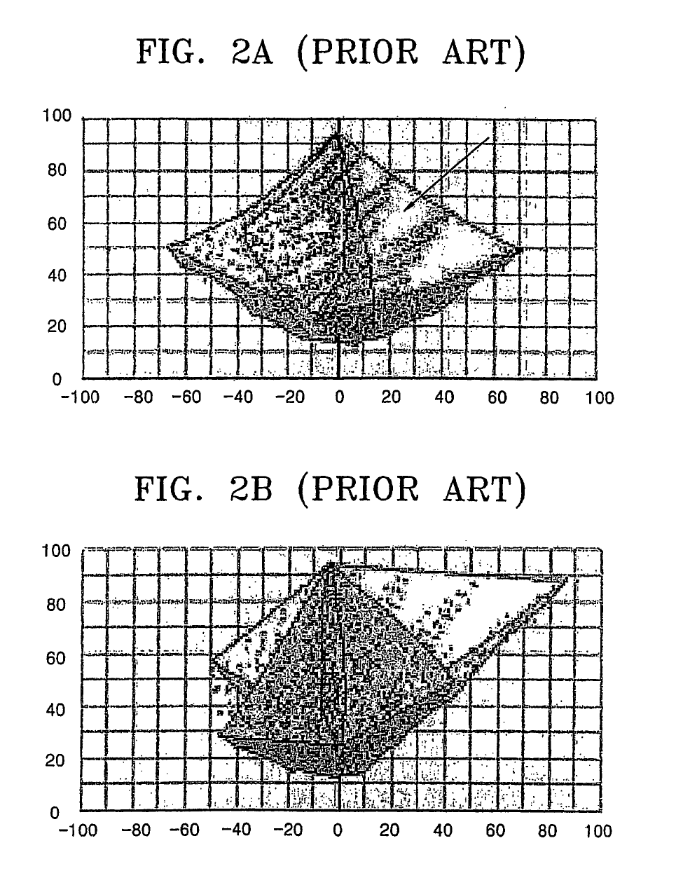

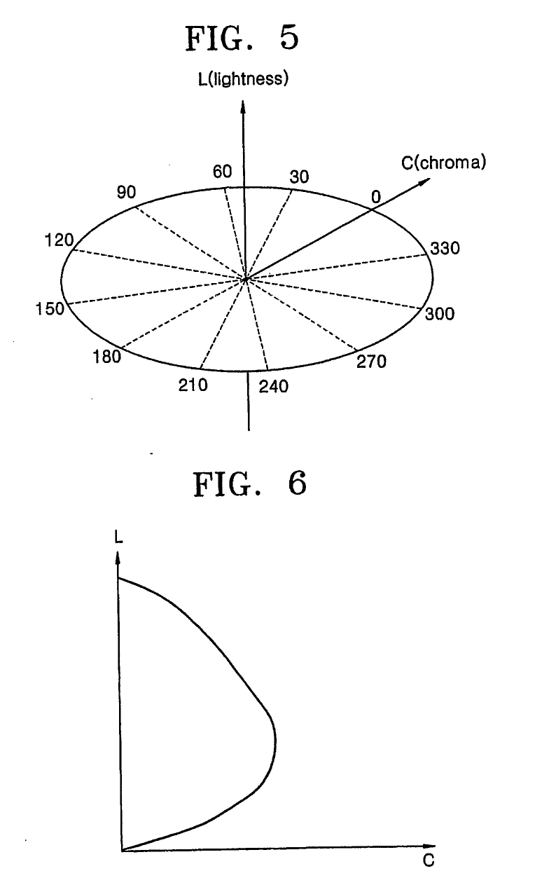

First, in sub-operation 30, the two-dimensional color sample corresponding to a predetermined angle is detected from a three-dimensional color space of the detected colorimetric value. The three-dimensional color space of the detected colorimetric value has a shape as illustrated in FIGS. 2A and 2B. FIG. 5 illustrates how a color sample can be represented in a three-dimensional color space for a detected colorimetric or measured value according to angle. As illustrated in FIG. 5, a two-dimensional color sample, which is represented in a coordinate with a lightness axis and a chroma axis, can be detected for an angle of 30°. Lightness denotes the degree of brightness of a color and is one of three colormaking attributes, the other two attributes of which are a hue and a chroma. As the lightness increases, every color becomes white. As the lightness decreases, every color becomes black. A chroma denotes the degree of purity of a color. In a color tone, a color with the maximum chroma is called a solid color. As the chroma decreases, every color becomes gray.

A two-dimensional color sample at a predetermined angle is detected from the three-dimensional color space of the detected colorimetric value. FIG. 6 illustrates a part of measured area or gamut of a two-dimensional color sample at a particular angle detected from the three-dimensional color space. A curved line of FIG. 6 indicates the gamut boundary of the two-dimensional color sample.

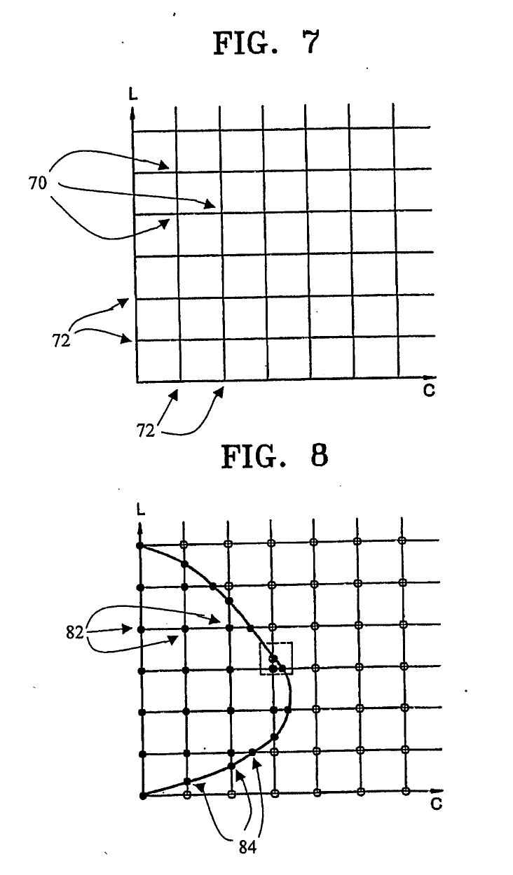

In sub-operation 32, a virtual coordinate table composed of square lattices is matched with the detected two-dimensional color sample. FIG. 7 illustrates an example of the virtual coordinate table. As illustrated in FIG. 7, the virtual coordinate table is formed to indicate coordinate values of a lightness and a chroma at intervals of a square lattice. The virtual coordinate table of FIG. 7 is matched with the two-dimensional color sample detected in sub-operation 30. The virtual coordinate table includes lattice intersection points 70 and lattice grid lines 72.

In sub-operation 34, points of contact between the two-dimensional color sample and the virtual coordinate table are detected. FIG. 8 illustrates the points of contact or correspondence detected by matching or mapping the two-dimensional sample with or to the virtual coordinate table or lattice. As illustrated in FIG. 8, the contact points are indicated as black dots and set as coordinates of the two-dimensional color sample. The contact points include points 82 that correspond to the lattice points or lattice intersection points and points 84 that correspond to intersection between the gamut boundary and the lattice grid lines.

Particularly, when some of the contact points exist within a first coordinate distance, a contact point having the greatest chroma coordinate value is detected. The first coordinate distance may be set as a distance smaller than half of a distance between lattices points of the virtual coordinate table. Referring to FIG. 8, three contact points are located in a dotted line. Although the three contact points may be all detected, it is prefered to detect the contact point having the greatest chroma coordinate value in the contact points.

In sub-operation 36, the detected contact points are inversely interpolated or mapped using color correspondence information to produce a new color chart. The color correspondence information indicates one-to-one correspondence between the standard color chart and the detected colorimetric value for the standard color chart. In other words, the contact points detected in sub-operation 34 are inversely interpolated using information indicating one-to-one correspondence between the standard color chart and the detected colorimetric value for the standard color chart, and a new color chart is produced by this inverse interpolation.

Inverse interpolation denotes a transformation or mapping of a CIELAB value or a CIEXYZ value into RGB or CMYK by a colorimetric value detection unit.

Referring back to FIG. 3, operation 14 is followed by operation 16 of outputting the new color chart through an image output unit. Operation 16 is performed to verify whether the new color chart can reduce errors in a color image.

In operation 18, a colorimetric value of the new color chart output is detected. Similar to operation 12, the colorimetric value of the new color chart output is detected by the colorimetric value detection unit.

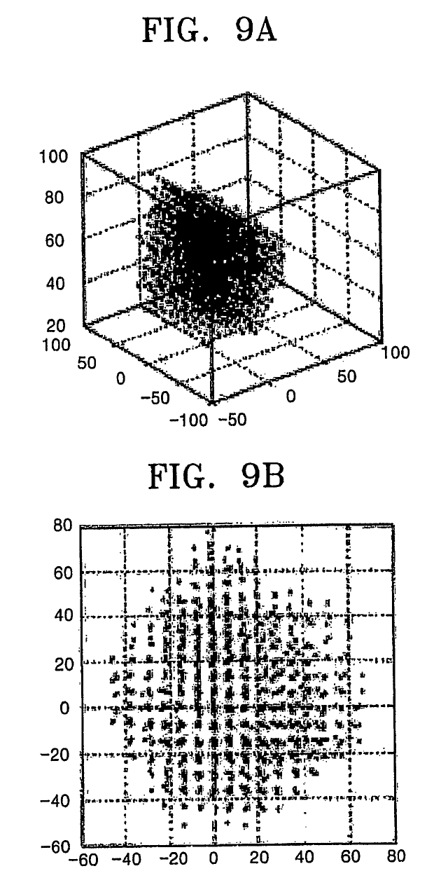

FIGS. 9A and 9B are three-dimensional and two-dimensional color spaces, respectively, of the colorimetric value of the new color chart. As illustrated in FIGS. 9A and 9B, color samples are more evenly distributed even around a limit or great boundary area in the new color chart than in the standard color chart.

In operation 20, it is determined whether color samples of the detected colorimetric value are evenly distributed in the three-dimensional color space. If a distance between color samples in the three-dimensional color space is smaller than or equal to a second coordinate distance, the color samples are evenly distributed in the three-dimensional color space. The second coordinate distance denotes a limit distance enough to determine that color samples are evenly distributed. The second coordinate distance may set in a predetermined length.

When it is determined in operation 20 that the color samples of the detected colorimetric value are evenly distributed in the three-dimensional color space, a color profile is produced by creating a table with the colorimetric values and the new color chart, in operation 22. When the color samples of the detected colorimetric value are evenly distributed in the three-dimensional color space, the new color chart formed based on the color samples is relatively ideal. Hence, when the color samples of the detected colorimetric value are evenly distributed in the three-dimensional color space, a color profile based on the new color chart is produced.

When it is determined in operation 20 that the color samples of the detected colorimetric value are not evenly distributed in the three-dimensional color space, the new color chart formed based on the color samples is not ideal. Hence, when the color samples of the detected colorimetric value are not evenly distributed in the three-dimensional color space, the method goes back to operation 14 to produce a new color chart.

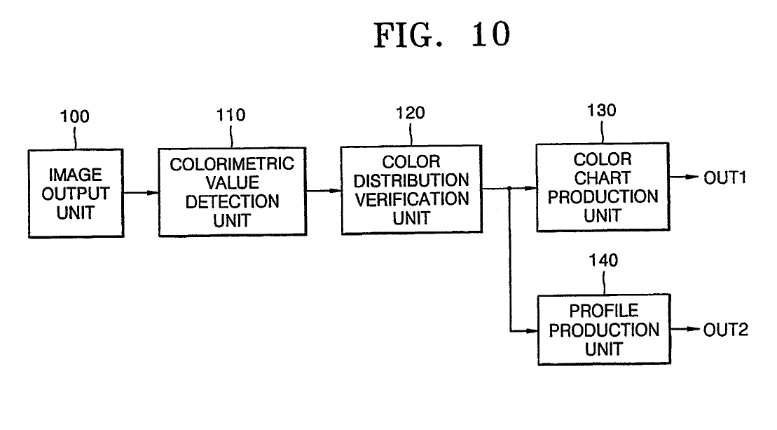

An apparatus for producing a new color chart according to an embodiment of the present invention will now be described with reference to FIG. 10. Referring to FIG. 10, the apparatus includes an image output unit 100, a colorimetric value detection unit 110, a color distribution verification unit 120, a color chart production unit 130, and a profile production unit 140.

The image output unit 100 outputs a standard color chart represented in RGB, CMYK, or the like. Examples of the image output unit 100 include an image printer, a multi-functional machine, a computer monitor for displaying an image represented in RGB, and the like.

The colorimetric value detection unit 110 detects a colorimetric value of the standard color chart output by the image output unit 100. Examples of the colorimetric value detection unit 110 include a spectrophotometer, a colorimeter, a densitometer, and the like.

The color distribution verification unit 120 verifies whether color samples of the detected colorimeter value are evenly distributed in a three-dimensional color space. When a distance between color samples in the three-dimensional color space is smaller than or equal to a second coordinate distance, the color distribution verification unit 120 verifies that the color samples are evenly distributed in the three-dimensional color space. The second coordinate distance may be predetermined and stored in the color distribution verification unit 120. The color distribution verification unit 120 receives the colorimetric value from the colorimetric value detection unit 110, verifies whether the color samples of the detected colorimeter value are evenly distributed in the three-dimensional color space, and outputs the results of the verification to the color chart production unit 130 and the profile production unit 140.

In response to the verification results, the color chart production unit 130 produces a new color chart by reconstructing the standard color chart using the detected colorimetric value and outputs the new color chart via a first output port OUT1.

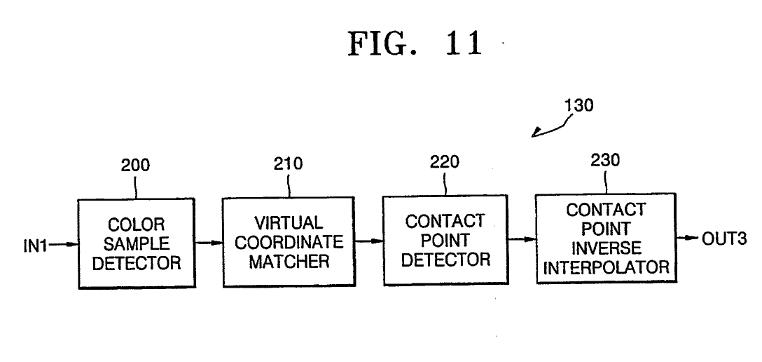

FIG. 11 is a block diagram of the color chart production unit 130, which includes a color sample detector 200, a virtual coordinate or mapping matcher 210, a contact or corresponding point detector 220, and a contact point inverse or mapper interpolator 230 according to an aspect of the present inventions.

The color sample detector 200 receives the result of the verification from the color distribution verification unit 120 via a first input port IN1, detects a two-dimensional color sample for an a predetermined angle from the three-dimensional color space of the detected colorimetric value, and outputs the two-dimensional color sample to the virtual coordinate matcher 210.

The virtual coordinate matcher 210 receives the two-dimensional color sample from the color sample detector 200, matches the same with a virtual coordinate table composed of square lattices, and outputs the result of the matching to the contact point detector 220.

The contact point detector 220 receives the result of the matching from the virtual coordinate matcher 210, detects points of contact between the two-dimensional color sample and the virtual coordinate table from the result of the matching, and outputs the detected contact points to the contact point inverse interpolator 230.

When some of the contact points exist within a first coordinate distance, the contact point detector 220 detects a contact point having the greatest chroma coordinate value among the contact points. The first coordinate distance may denote a distance smaller than half of a distance between lattices of the virtual coordinate table. The first coordinate distance may set in a predetermined length long and stored in the contact point detector 220.

The contact point inverse interpolator 230 receives detected contact points, inversely interpolates the same using color correspondence information, and outputs a new color chart produced by the inverse interpolation of the detected contact points via a third output port OUT3. The color correspondence information indicates one-to-one correspondence between the standard color chart and the detected colorimetric value for the standard color chart.

Referring back to FIG. 10, in response to the result of the verification by the color distribution verification unit 120, the profile production unit 140 produces a color profile by tabling the colorimetric value and the new color chart and outputs the color profile via a second output port OUT2.

The units 120, 130 and 140 can be a computer system.

As described above, a new color chart produced according to an embodiment of the present invention enables a device-independent color space to have a uniform color distribution. Thus, an interpolation weight obtained from the device-independent color space is stable, an error in a color image output by a printer or the like is minimized, and an effective gray balance can be obtained.

Although a few embodiments of the present invention have been shown and described, it would be appreciated by those skilled in the art that changes may be made in these embodiments without departing from the principles and spirit of the invention, the scope of which is defined in the claims and their equivalents.

1. A method of producing a new color chart, comprising:
generating a standard color chart;
detecting colorimetric values of the standard color chart output; and
producing a new color chart by reconstructing the standard color chart using the colorimetric value.

2. The method of claim 1, wherein the producing of the new color chart comprises:
detecting a two-dimensional color sample for predetermined angle from the three-dimensional color space of the colorimetric value;
matching a virtual coordinate table with the two-dimensional color sample;
detecting points of contact between the two-dimensional color sample and the virtual coordinate table; and
producing the new color chart by inversely interpolating the detected contact points using color correspondence information indicating one-to-one correspondence between the colorimetric value and the standard color chart.

3. The method of claim 2, wherein in the detecting of the contact points, when some of the contact points between a gamut boundary area of the two-dimensional color sample and the virtual coordinate table exist within a first coordinate distance, a contact point having the greatest chroma coordinate value is detected in the contact points.

4. The method of claim 1, further comprising:
after the producing of the new color chart, outputting the new color chart;
detecting a colorimetric value of the new color chart output;
verifying whether color samples of the colorimetric value are evenly distributed in the three-dimensional color space; and
producing a color profile by tabling the colorimetric value and the new color chart when the color samples of the colorimetric value are evenly distributed in the three-dimensional color space

5. The method of claim 2, further comprising:
when the color sample of the colorimetric value are not evenly distributed in the three-dimensional color space, performing the operation repeat.

6. The method of claim 4, wherein in the verification, when a distance between color samples in the three-dimensional color space is no greater than a second coordinate distance, it is determined that the color samples are evenly distributed in the three-dimensional color space.

7. An apparatus for producing a new color chart, comprising:
an image output unit outputting a standard color chart;
a colorimetric value detection unit detecting a colorimetric value of the standard color chart output by the image output unit; and
a color chart production unit producing a new color chart by reconstructing the standard color chart using the colorimetric value.

8. The apparatus of claim 7, wherein the color chart production unit comprises:
a color sample detector detecting a two-dimensional color sample for a predetermined angle from the three-dimensional color space of the colorimetric value;
a virtual coordinate matcher matching a virtual coordinate table with the two-dimensional color sample;
a contact point detector detecting points of contact between the two-dimensional color sample and the virtual coordinate table; and
a contact point inverse interpolator producing the new color chart by inversely interpolating the detected contact points using color correspondence information indicating one-to-one correspondence between the colorimetric value and the standard color chart.

9. The apparatus of claim 8, wherein when some of the contact points between a limit area of the two-dimensional color sample and the virtual coordinate table exist within a first coordinate distance, the contact point detector detects a contact point having the greatest chroma coordinate value in the contact points.

10. The apparatus of claim 7, further comprising:
a color distribution verification unit verifying whether color samples of the colorimetric value are evenly distributed in the three-dimensional color space:

11. The apparatus of claim 10, wherein when a distance between color samples in the three-dimensional color space is no greater than a second coordinate distance, the color distribution verification unit determines that the color samples are evenly distributed in the three-dimensional color space.

12. The apparatus of claim 7, wherein the image output unit is one of a printer, a multi-functional machine, and a computer monitor.

13. The apparatus of claim 7, further comprising:
a profile production unit producing a color profile by tabling the colorimetric value and the new color chart.

14. The apparatus of claim 8, wherein the virtual coordinate table is composed of square lattices.

15. A method of producing a new color chart, comprising:
detecting a colormetric value of a standard color chart;
detecting a two-dimensional color space for a predetermined angle for the three-dimensional color space of the colormetric value;
matching a virtual coordinate table with the two-dimensional color sample;
detecting points of contact between the two-dimensional color sample and the virtual coordinate table; and
producing the new color chart.

16. The method of claim 14, further comprising:
wherein the color chart is produced by inversely interpolating the detected contact points using color correspondence information indicating one-to one correspondence between the colormetric value and the standard color chart.

17. A method, comprising:
generating a standard color chart with a color chart generating device;
measuring color values of the generated standard color chart;
determining a three dimensional gamut of the color chart generating standard;
mapping a three dimensional lattice onto the gamut;
mapping lattice intersection points corresponding to the gamut and lattice axial points corresponding to a gamut boundary points to the color space of the output device; and
creating a lattice point color chart from intersection and axial points in the color space.

18. A method of producing a color profile of a generating device, comprising:
generating a standard color chart with the device;
measuring color values of the generated standard color chart;
determining a three dimensional gamut of the generating standard color chart;
mapping a three dimensional lattice onto the gamut;
mapping lattice intersection points corresponding to the gamut and lattice axial points corresponding to a gamut boundary points to the color space of the output device;
creating a lattice point color chart from intersection and axial points in the color space; and
creating an output device color profile from the lattice point color chart.

19. A method, comprising:
generating a standard color chart with a generate device;
mapping a gamut of the color chart onto a lattice; and
mapping lattice points of the lattice to a lattice point color chart of a color space of the output device.
